(19) United States
(12) Patent Application Publication
(10) Pub. No.: US 2007/0126997 A1
(43) Pub. Date: Jun. 7, 2007

(54) Digital micro-mirror device assembly and optical projection system using the same

(75) Inventor: Byung-jo Kang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/487,373

(22) Filed: Jul. 17, 2006

(30) Foreign Application Priority Data
Dec. 5, 2005 (KR) 2005-117719

(51) Int. Cl. G03B 21/28; G03B 21/22; G03B 21/14

(52) U.S. Cl. 353/99; 353/119

(57) ABSTRACT

An optical projection system is disclosed. The optical projection system includes a base, a lamp provided in the base, a DMD assembly provided at one side of the lamp to generate image light from light irradiated by the lamp, and a projection unit for projecting the image light formed through the DMD assembly. The DMD assembly includes a DMD, a main circuit board provided with the DMD at one side, and a side circuit board which may be detached from or fixed to the main circuit board independently from the DMD assembly. The side circuit board may be provided at one side of the main circuit board at a right angle.

### CROSS-REFERENCE TO RELATED APPLICATIONS

This application claims the benefit under 35 U.S.C. § 119(a) of Korean Patent Application No. 2005-117719, filed on Dec. 5, 2005, the entire content of which is hereby incorporated by reference.

### BACKGROUND OF THE INVENTION

1. Field of the Invention

The present invention relates to an optical projection system. More particularly, the present invention relates to an optical projection system having an improved circuit board structure.

1. Description of the Related Art

An optical projection system projects a small sized image onto a large screen using an optical means. Typical types of optical projection systems include cathode ray tube (CRT) projection systems, liquid crystal display (LCD) projection systems, and digital light processing (DLP) projection systems.

CRT projection systems are the oldest and form an image on a screen by reflecting a small sized CRT with a mirror. LCD projection systems transmit an external image signal to a projection TV to reproduce the image signal on a small sized LCD screen having a diameter of around four inches. The image displayed on the screen is irradiated by strong light from the rear of a liquid crystal screen and passed through a lens to enlarge the image. The image is then reflected by a mirror so that the reflected image is projected onto the screen.

DLP projection systems enlarge and project an externally input image signal using a digital micro-mirror device (DMD) semiconductor chip in which hundreds of thousands of fine driving mirrors are integrated.

An example of an optical projection system based on a DMD semiconductor chip is disclosed in the U.S. Pat. No. 6,791,838 (issued on Sep. 14, 2004 and assigned to Lite-On Technology Corporation), which is hereby incorporated by reference in its entirety.

FIG. 1 illustrates the DMD assembly disclosed in the U.S. Pat. No. 6,791,838.

Referring to FIG. 1, the DMD assembly includes a heat-sink element 1, a DMD module 2, an optical holder 3, a flexible element 4, and a locking element 5.

The heat-sink element 1 has a plurality of receiving holes 10 formed around the edges of the heat-sink element and a heat conduction body 11 that protrudes from the bottom of the heat sink element. The heat conduction body 11 is either assembled to or integrally formed on a heat-sink fin 12 of the heat-sink element 1. The DMD module 2 has a control board 20, a DMD 21, a fixed holder 22 arranged around the DMD, and an upper cover 23. The upper cover 23 transfers information from the control board 20 to the DMD 21. The control board 20 has an opening 200 and a first fixing element (which comprises a plurality of through holes 201a) formed around the opening 200. The upper cover 23 has an opening 230 that corresponds to the heat conduction body 11 of the heat-sink element 1. The heat conduction body 11 of the heat-sink element 1 passes through the opening 200 of the control board 20 to touch the rear 210 of the DMD 21, for controlling the angular change of a plurality of micro mirrors 211 of DMD 21.

The optical holder 3 has a second fixing element (which comprises a plurality of assembly holes 30a) arranged thereon, and an assembly interface 31a adapted for assembling the DMD module 2 therein.

The flexible element 4 disposed in the receiving hole 10 of the heat-sink element 1 has a plurality of compressing springs 4a while the locking element 5 has a plurality of locking bolts 5a.

In the aforementioned optical projection system, if the control board 20 is replaced with another control board (due to, for example, a defect), the heat-sink element 1, the DMD module 2 and the optical holder 3 must be disassembled because they are fixed to the control board 20 through the locking element 5 to form a single body,

For this reason, if the control board 20 is replaced with another one, the DMD module 2 may be moved, which deteriorates projection efficiency. Therefore, the DMD module 2 must be precisely positioned. However, it is difficult to perform the positioning operation properly. In particular, it is difficult to perform the positioning operation at locations not provided with positioning equipment, such as a consumer's home. Therefore, the whole engine may need to be replaced with a new one if position equipment is not available.

Accordingly, there is a need for an improved DMD assembly which avoids the need to replace the whole engine if there is a defect in the DMD module.

### SUMMARY OF THE INVENTION

An aspect of the present invention is to address at least the above problems and/or disadvantages and to provide at least the advantages described below. Accordingly, an aspect of the present invention is to provide a DMD assembly and an optical projection system using the same, which substantially obviates one or more of problems caused by the limitations and disadvantages in conventional DMD assemblies.

Another aspect of the present invention is to provide a DMD assembly and an optical projection system using the same, in which the structure of the circuit board is improved to facilitate replacement of the circuit board.

Yet another aspect of the present invention is to provide a DMD assembly and an optical projection system using the same, in which the structure of the circuit board is improved so that the circuit board may be replaced without requiring a positioning operation of a DMD.

In accordance with an exemplary embodiment of the present invention, an optical projection system includes a base, a lamp provided in the base, a DMD assembly provided at one side of the lamp to generate an image light from light irradiated by the lamp, and a projection unit for projecting the image light formed by the DMD assembly. The DMD assembly includes a DMD, a main circuit board provided with the DMD at one side, and a side circuit board detached from or fixed to the main circuit board independently from the DMD assembly.

The side circuit board may be provided at one side of the main circuit board at a right angle.

The optical projection system may further include a main connector provided at one side of the main circuit board and a side connector provided at one side of an end of the side circuit board and electrically connected with the main connector.

The optical projection system may further include a main housing covering the main circuit board, and the main housing may be provided with a side connector through hole to pass the side connector therethrough.

The optical projection system may further include a side housing for covering the side circuit board.

The side housing may be fixed to the main housing by a locking unit. The locking unit may include a main locked edge projected at both edges of the main housing, having a main locking hole, a side locked edge projected at both sides of the side housing to correspond to the main locked edge, having a side locking hole, and side housing locking screws fitted into the main locking hole and the side locking hole.

The main housing and the side housing may be additionally provided with a side locking unit. The side locking unit may include at least one fitting slot formed at one side of the main housing, and a fitting bar formed at one side of the side housing and fitted into the fitting slot.

The main circuit board may have a vertical plane with respect to the base.

The side housing may include a pair of first and second side housings, the first side housing being provided with a side projection at an outer side, and the second side housing being provided with a side locking edge locked in the side projection and a side slit that allows the side locking edge to be elastically moved and locked in the side projection.

At least one of the first side housing or the second side housing may have a radiating hole.

The side housing may be provided with a side housing locking hole fixed to the side circuit board, and the side circuit board may be provided with a side circuit board locking hole corresponding to the side housing locking hole to fit a side circuit board locking screw thereinto.

The side circuit board may be provided with a circuit part having a high defect ratio.

In accordance with another exemplary embodiment of the present invention, a DMD assembly includes a DMD for reproducing light required to form an image, a main circuit board provided with the DMD, and a side circuit board detached from or fixed to the main circuit board independently from the DMD.

The side circuit board may have a vertical plane with respect to the main circuit board.

The main circuit board may be additionally provided with a main connector, and the side circuit board may be additionally provided with a side connector connected with the main connector.

The side circuit board may be provided with a circuit part having a high defect ratio.

In accordance with another exemplary embodiment of the present invention, a digital micro-mirror device (DMD) assembly includes a DMD for forming an image, a first circuit board for mounting the DMD, and a second circuit board detachably mounted to the first circuit board so that the second circuit board may be detached and mounted independently from the DMD.

The second circuit board may be mounted substantially perpendicular to the first circuit board.

The DMD assembly may further include a main connector disposed on the first circuit board, and a side connector disposed on the second circuit board for connection with the main connector.

A circuit part having a high defect ratio may be disposed on the second circuit board.

In accordance with yet another exemplary embodiment of the present invention, an optical projection system comprises a base, a light source disposed in the base, a digital micro-mirror device (DMD) assembly for receiving light from the light source and forming image light from the received light, and a projection unit for projecting the image light formed by the DMD assembly. The DMD assembly includes a DMD, a first circuit board for mounting the DMD, and a second circuit board detachably mounted to the first circuit board so that the second circuit board may be detached and mounted independently from the DMD.

The second circuit board may be substantially perpendicular to the first circuit board.

A main connector may be disposed on the first circuit board, and a side connector may be disposed on the second circuit board for connection with the main connector.

The optical projection system may further include a main housing covering the first circuit board, and the main housing may be provided with a side connector through hole to pass the side connector therethrough.

The optical projection system may further include a side housing for covering the second circuit board.

The side housing may be fixed to the main housing by a locking unit. The locking unit may include a main locked edge projected at both edges of the main housing, having a main locking hole, a side locked edge projected at both sides of the side housing to correspond to the main locked edge, having a side locking hole, and side housing locking screws fitted into the main locking hole and the side locking hole.

The main housing and the side housing may be additionally provided with a side locking unit. The side locking unit may include at least one fitting slot formed at one side of the main housing, and a fitting bar formed at one side of the side housing and fitted into the fitting slot.

A circuit part having a high defect ratio may be disposed on the second circuit board.

The side housing may include a pair of first and second side housings, the first side housing being provided with a side projection at an outer side, and the second side housing being provided with a side locking edge locked in the side projection and a side slit that allows the side locking edge to be elastically moved and locked in the side projection.

At least one of the first side housing or the second side housing may have a radiating hole.

The side housing may be provided with a side housing locking hole fixed to the second circuit board, and the second circuit board may be provided with a second circuit board locking hole corresponding to the side housing locking hole to fit a second circuit board locking screw thereinto.

The second circuit board may be provided with a circuit part having a high defect ratio.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 illustrates a conventional DMD assembly as disclosed in U.S. Pat. No. 6,791,838;

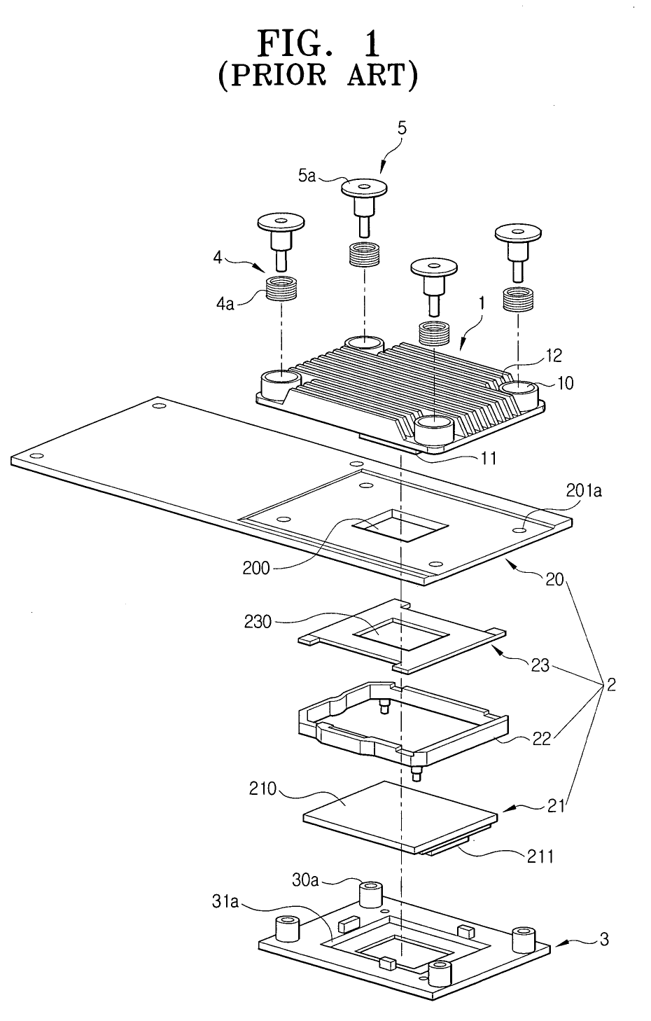

FIG. 2 is a perspective view of an optical projection system according to an exemplary embodiment of the present invention;

FIG. 3 is an enlarged perspective view of a DMD assembly of FIG. 2;

FIG. 4 is a perspective view of the DMD assembly of FIG. 3, viewed from another direction;

FIG. 5 is an exploded perspective view of a DMD assembly according to another exemplary embodiment of the present invention;

FIG. 6 is an enlarged view of the area indicated by VI in FIG. 5; and

FIG. 7 is a perspective view of the structure of the main circuit board of FIG. 5 as it is electrically connected with a side circuit board.

Throughout the drawings, the same reference numerals will be understood to refer to the same elements, features, and structures.

### DETAILED DESCRIPTION OF THE EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

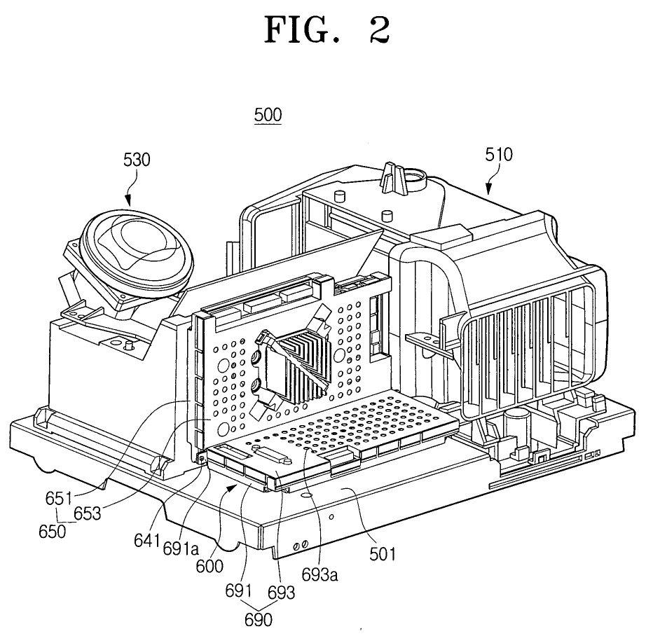

FIG. 2 is a perspective view of an optical projection system according to one embodiment of the present invention.

Referring to FIG. 2, the optical projection system 500 includes a base 501, a lamp 510, a DMD assembly 600, and a projection lens 530. The light emitted from the lamp 510 is reflected toward the projection lens 530 by a DMD of the DMD assembly 600, and the reflected light is projected onto a projection surface of a screen (not shown).

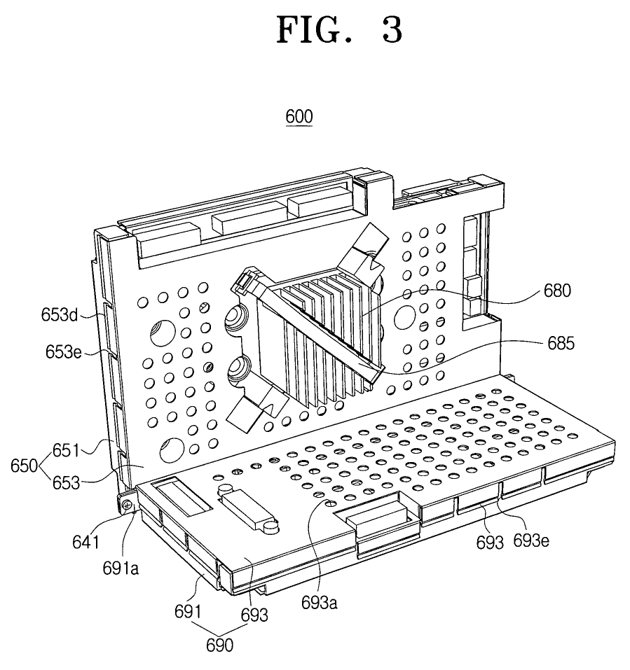

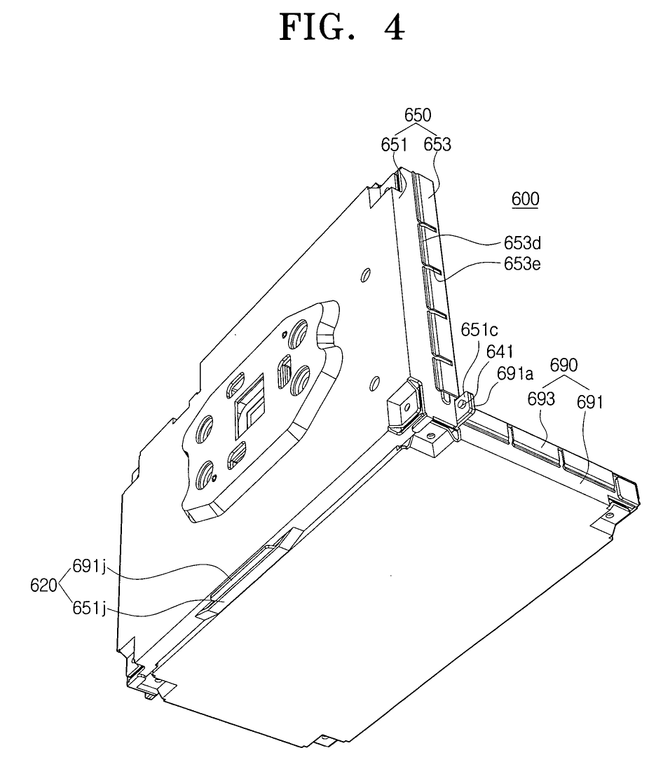

FIG. 3 is an enlarged perspective view of the DMD assembly of FIG. 2, and FIG. 4 is a perspective view of the DMD assembly of FIG. 3, viewed from another direction.

Referring to FIG. 3 and FIG. 4, the DMD assembly 600 includes a main housing 650 and a side housing 690. A DMD 610 and a main circuit board 630 are provided in the main housing 650. The side housing 690 is provided a side circuit board 670 at a predetermined angle, for example, a right angle, with respect to the main housing 650.

The main housing 650 comprises a pair of first and second main housings 651 and 653. A heat sink 680 is provided outside the second main housing 653. The heat sink 680 radiates heat generated by the DMD 610 or the main circuit board 630.

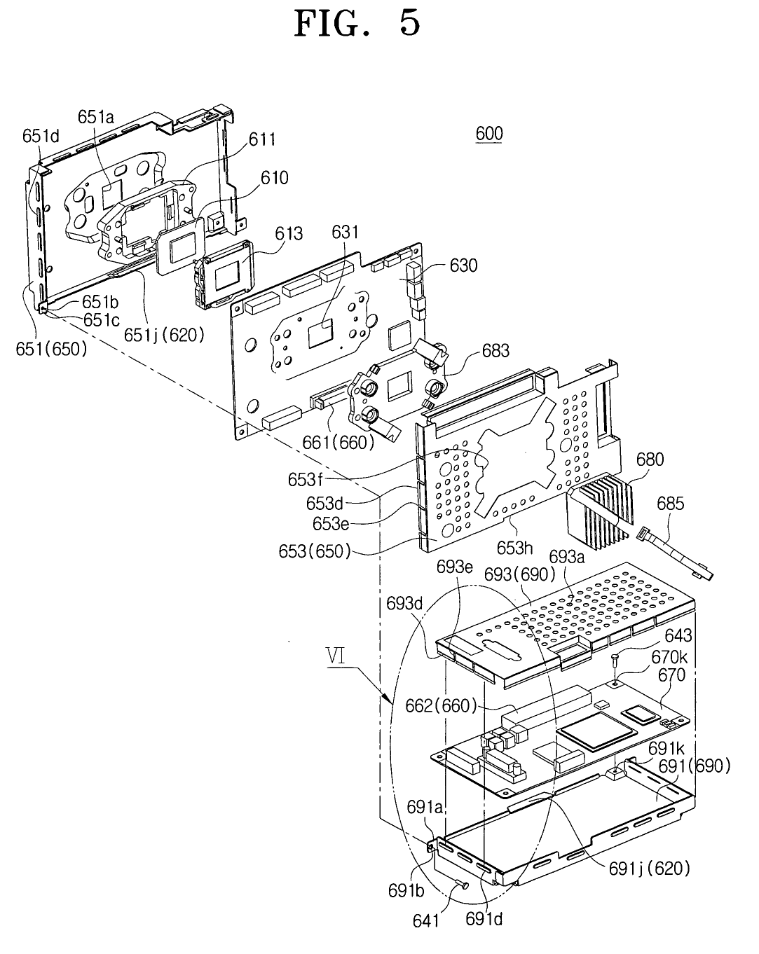

The side housing 690 comprises a pair of first and second side housings 691 and 693. The second side housing 693 is provided with a plurality of radiating holes 693a that emit heat generated from the side circuit board 670 (see FIG. 5). The radiating holes 693a may be formed in the first side housing 691.

Side locking edges 691a are provided at both sides of the first side housing 691 and are fixed to the second main housing 653 through side housing locking screws 641.

Referring to FIG. 4, the first main housing 651 and the first side housing 691 are provided with a side locking unit 620. The side locking unit 620 is comprised of a fitting slot 651j and a fitting bar 691j. The fitting slot 651j is formed at the bottom of the first main housing 651 while the fitting bar 691j is formed at one end of the first side housing 691.

FIG. 5 is an exploded perspective view of the DMD assembly according to an exemplary embodiment of the present invention.

Referring to FIG. 5, the DMD assembly 600 includes a main housing 650, a DMD 610, a main circuit board 630, a side housing 690, a side circuit board 670, and a heat sink 680.

The main circuit board 630 provided with the DMD 610 is provided on one side inside the main housing 650. The DMD 610 is supported in the first main housing 651 by a holder 611, and is connected with the main circuit board 630 through a socket 613.

The main circuit board 630 is provided with a rectangular hole 631 to allow the DMD 610 to pass through it. At this time, the main circuit board 630 and the side circuit board 670 are electrically connected with each other through a connector 660 (661, 662). If a defect occurs in the side circuit board 670 due to a circuit part having a high defect ratio such as DMD operation I.C(Integrated Circuit) and color wheel operation I.C provided on the side circuit board 670, the side circuit board 670 may be fixed to or detached from the main circuit board 630 independently from the DMD 610.

The main housing 650 includes a pair of first and second main housings 651 and 653. The first main housing 651 is provided with a housing rectangular hole 651a corresponding to the DMD 610. A plurality of main projections 651d are formed at an outside edge of the first main housing 651 while a plurality of main locking edges 653d are formed at an outside edge of the second main housing 653 to correspond to the main projections 651d. At this time, a plurality of main slits 653e are formed at the side of the second main housing 653 to provide elasticity so that the main locking edges 653d can be fixed to the main projections 651d along outer surfaces of the main projections 651d.

The second main housing 653 is provided with a heat sink hole 653f at the center thereof to pass the heat sink 680 therethrough. The heat sink 680 is partially inserted into the heat sink hole 653f, and one side of the heat sink 680 inserted into the heat sink hole 653f contacts the DMD 610 to emit heat generated from the DMD 610. The heat sink 680 is supported on the main circuit board 630 through a bracket 683 and a spring 685.

The side housing 690 includes a pair of first and second housings 691 and 693. Side locking edges 691a provided with side locking holes 691b are respectively formed at both sides of the first side housing 691. Main locking edges 651c are additionally formed at both sides of the first main housing 651. The main locking edges 651c are provided with main locking holes 651b corresponding to the side locking holes 691b. A plane of the side housing 690 is fixed vertically with respect to a plane of the main housing 650 by fitting the side housing locking screws 641 into the side locking holes 691b and the main locking holes 651b.

The first side housing 691 is provided with a side housing locking hole 691k fixed to the side circuit board 670 while the side circuit board 670 is provided with a side circuit board locking hole 670k to correspond to the side housing locking hole 691k, thereby fitting a side circuit board locking screw 643 into the side circuit board locking hole 670k.

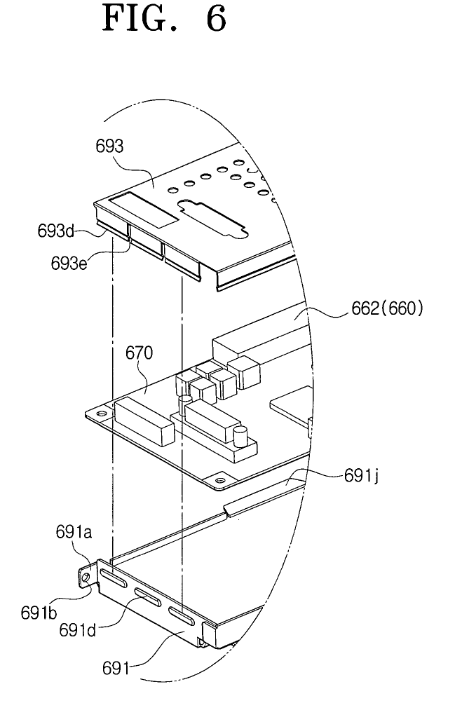

FIG. 6 illustrates an enlarged view of a portion VI of FIG. 5.

Referring to FIG. 6, the first side housing 691 is provided with a plurality of projections 691d at the outer side corresponding to the first main housing 651. Also, the second side housing 693 is provided with a plurality of side locking edges 693d and a plurality of side slits 693e at the side corresponding to the second main housing 653. Therefore, after the second side housing 693 is fitted into the outer surface of the first side housing 691, the side locking edges 693d are locked in the side projections 691d in the same manner as the main housing 650.

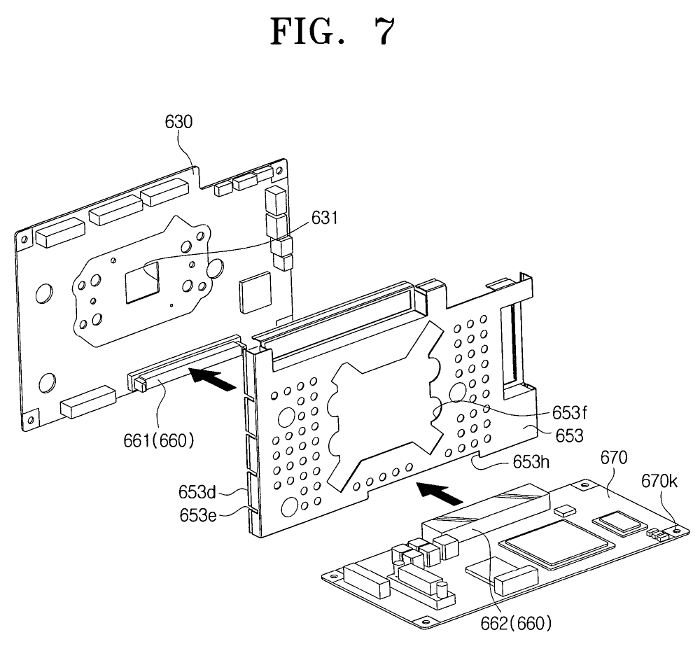

FIG. 7 illustrates a structure that the main circuit board of FIG. 5 is electrically connected with the side circuit board thereof.

The main circuit board 630 is provided with a main connector 661 at one end, and the side circuit board 670 is provided with a side connector 662 at one end. The second main housing 653 is provided with a connecting through hole 653h at the bottom to pass the side connector 662 therethrough.

The main housing 650 and the side housing 690 may be formed of a metal material.

The assembly and disassembly operation of the above-described DMD assembly for an optical projection system according to an exemplary embodiment of the present invention will now be described.

Referring to FIG. 5, the DMD 610 is fixed to the side of the main circuit board 630 through the socket 613. Then, the main circuit board 630 is mounted in the first main housing 651. Afterwards, the main circuit board 630 is fixed to the first main housing 651 through a screw (not shown). At this time, the DMD 610 passes through the rectangular hole 631 of the main circuit board 630.

Next, the bracket 683 is connected with one side of the main circuit board 630.

Subsequently, the second main housing 653 is fitted into the first main housing 651. At this time, the main locking edges 653d move along the outer surfaces of the main projections 651d formed the outer side of the first main housing 651 and then return to the original position. Thus, the main locking edges 653d are locked in the main projections 651d.

As described above, if the second main housing 653 is fixed to the first main housing 651, the heat sink 680 is inserted into the heat sink hole 653f and then connected to the bracket 683 through the spring 685.

Next, after the side circuit board 670 is positioned inside the first side housing 691, the side circuit board screw 643 is fitted into the side housing locking hole 691k and the side circuit board locking hole 670k.

Afterwards, the second side housing 693 is fitted into the first side housing 691. At this time, the side locking edges 693d formed at the side of the second side housing 693 move along the side slits 693e in the same manner as the main locking edges 653d. Therefore, the side locking edges 693d move along the outer surfaces of the side projections 691d while the second side housing 693 is fitted into the outer surface of the first side housing 691. If the second side housing 693 is completely fitted into the outer surface of the first side housing 691, the side locking edges 693d return to the original position and are locked in the side projections 691d.

As described above, after the side circuit board 670 is provided inside the side housing 690 to form an assembly part, the side connector 662 formed in the side circuit board 670 is inserted into the side connector through hole 653h formed at the bottom of the second main housing 653, and at the same time the fitting bar 691j formed in the first side housing 691 is fitted into the fitting slot 651j formed at the bottom of the first main housing 651.

Meanwhile, if the side circuit board 670 is to be detached from the main circuit board 630 due to faulty operation of the circuit part such as DMD operation I.C(Integrated Circuit) and color wheel operation I.C provided in the side circuit board 670, the side housing locking screws 641 are detached from the side housing 690 and then the side housing 690 is pulled. In this case, the side circuit board 670 is simply detached from the main circuit board 630.

When the side circuit board 670 is detached from the main circuit board 670 as described above, the DMD 610 is maintained without being moved from the position that it is fixed to on the other side of the main circuit board 630.

Therefore, if the side circuit board 670 is detached from the main circuit board 670, no positioning operation of the DMD 610 is required.

The aforementioned assembly order is just exemplary, and may be varied as desired. The subject matter of the present invention is characterized in that the assembly and detachment operation of the side circuit board 670 is performed separately from the DMD 610 without changing the position of the DMD 610.

As described above, in the DMD assembly for the optical projection system according to the exemplary embodiment of the present invention, a circuit part having a high defect ratio is provided in a side circuit board, and the side circuit board may be detached from the main circuit board separately from the DMD without any positioning operation of the DMD. This configuration facilitates repair and maintenance of the DMD assembly.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An optical projection system comprising:
a base;
a light source provided in the base;
a digital micro-mirror device (DMD) assembly configured to receive light from the light source and form image light, the DMD assembly including:
a DMD;
a main circuit board provided with the DMD; and
a side circuit board which may be detached from or fixed to the main circuit board independently from the DMD assembly; and
a projection unit for projecting the image light formed by the DMD assembly.

2. The optical projection system as claimed in claim 1, wherein the side circuit board is disposed at a right angle to the main circuit board.

3. The optical projection system as claimed in claim 2, further comprising a main connector provided on the main circuit board and a side connector provided on the side circuit board and electrically connected with the main connector.

4. The optical projection system as claimed in claim 3, further comprising a main housing covering the main circuit board, the main housing having a side connector through hole for allowing the side connector to pass therethrough.

5. The optical projection system as claimed in claim 4, further comprising a side housing for covering the side circuit board.

6. The optical projection system as claimed in claim 5, wherein the side housing is fixed to the main housing by a locking unit.

7. The optical projection system as claimed in claim 6, wherein the locking unit comprises:
a main locked edge projecting from the main housing, the main locked edge having a main locking hole;
a side locked edge projecting from the side housing to correspond to the main locked edge, the side locked edge having a side locking hole; and
a side housing locking member fitted into the main locking hole and the side locking hole.

8. The optical projection system as claimed in claim 7, wherein the main housing and the side housing are provided with a side locking unit.

9. The optical projection system as claimed in claim 8, wherein the side locking unit comprises:
at least one fitting slot disposed on the main housing; and
a fitting bar disposed on the side housing and fitted into the fitting slot.

10. The optical projection system as claimed in claim 9, wherein the side circuit board includes a circuit part having a high defect ratio.

11. The optical projection system as claimed in claim 1, wherein the main circuit board has a vertical plane with respect to the base.

12. The optical projection system as claimed in claim 5, wherein the side housing comprises a pair of first and second side housings, the first side housing having a side projection, and the second side housing having a side locking edge locked in the side projection and a side slit for allowing the side locking edge to be elastically moved and locked in the side projection.

13. The optical projection system as claimed in claim 12, wherein at least one of the first side housing or the second side housing has a radiating hole.

14. The optical projection system as claimed in claim 5, wherein the side housing has a side housing locking hole fixed to the side circuit board, and the side circuit board has a side circuit board locking hole corresponding to the side housing locking hole for receiving a side circuit board locking member.

15. A digital micro-mirror device (DMD) assembly comprising:
a DMD for forming an image;
a main circuit board having the DMD; and
a side circuit board which may be detached from or fixed to the main circuit board independently from the DMD assembly.

16. The DMD assembly as claimed in claim 15, wherein the side circuit board is disposed vertically with respect to the main circuit board.

17. The DMD assembly as claimed in claim 16, wherein the main circuit board has a main connector, and the side circuit board has a side connector connected with the main connector.

18. The DMD assembly as claimed in claim 15, wherein the side circuit board has a circuit part having a high defect ratio.

19. A digital micro-mirror device (DMD) assembly comprising:
a DMD for forming an image;
a first circuit board for mounting the DMD; and
a second circuit board detachably mounted to the first circuit board so that the second circuit board may be detached and mounted independently from the DMD.

20. The DMD assembly of claim 19, wherein the second circuit board is substantially perpendicular to the first circuit board.

21. The DMD assembly as claimed in claim 19, further comprising:
a main connector disposed on the first circuit board; and
a side connector disposed on the second circuit board for connection with the main connector.

22. The DMD assembly as claimed in claim 15, wherein a circuit part having a high defect ratio is disposed on the second circuit board.

23. An optical projection system comprising:
a base;
a light source disposed in the base;
a digital micro-mirror device (DMD) assembly for receiving light from the light source and forming image light from the received light, the DMD assembly including:
a DMD;
a first circuit board for mounting the DMD; and
a second circuit board detachably mounted to the first circuit board to be detached and mounted independently from the DMD; and
a projection unit for projecting the image light.

24. The optical projection system as claimed in claim 23, wherein the second circuit board is substantially perpendicular to the first circuit board.

25. The optical projection system as claimed in claim 23, further comprising:
a main connector disposed on the first circuit board; and
a side connector disposed on the second circuit board for connection with the main connector.

26. The optical projection system as claimed in claim 25, further comprising a main housing covering the first circuit board, the main housing having a side connector through hole for allowing the side connector to pass therethrough.

27. The optical projection system as claimed in claim 26, further comprising a side housing for covering the second circuit board.

28. The optical projection system as claimed in claim 27, wherein the side housing is detachably mounted to the main housing by a locking unit.

29. The optical projection system as claimed in claim 28, wherein the locking unit comprises:
a main locked edge projecting from the main housing, the main locked edge having a main locking hole;
a side locked edge projecting from the side housing to correspond to the main locked edge, the side locked edge having a side locking hole; and
a side housing locking member fitted into the main locking hole and the side locking hole.

30. The optical projection system as claimed in claim 29, wherein the main housing and the side housing have a side locking unit.

31. The optical projection system as claimed in claim 30, wherein the side locking unit comprises:
at least one fitting slot disposed on the main housing; and
a fitting bar disposed on the side housing and fitted into the fitting slot.

32. The optical projection system as claimed in claim 31, wherein a circuit part having a high defect ratio is disposed on the second circuit board.

33. The optical projection system as claimed in claim 27, wherein the side housing comprises:
a first side housing having a side projection; and
a second side housing having a side locking edge locked in the side projection and a side slit for allowing the side locking edge to be elastically moved and locked in the side projection.

34. The optical projection system as claimed in claim 33, wherein at least one of the first side housing or the second side housing has a radiating hole.

35. The optical projection system as claimed in claim 27, wherein the side housing has a side housing locking hole fixed to the second circuit board, and the second circuit board has a second circuit board locking hole corresponding to the side housing locking hole for receiving a second circuit board locking member.

36. The optical projection system as claimed in claim 23, wherein a circuit part having a high defect ratio is disposed on the second circuit board.
